(19) United States
(12) Patent Application Publication
(10) Pub. No.: US 2014/0351380 A1
(43) Pub. Date: Nov. 27, 2014

(54) LOADING IMAGE INFORMATION

(71) Applicant: Alibaba Group Holding Limited, Grand Cayman (KY)

(72) Inventor: Zhiwen Mi, Hangzhou (CN)

(73) Assignee: Alibaba Group Holding Limited, Grand Cayman (KY)

(21) Appl. No.: 14/276,970

(22) Filed: May 13, 2014

(30) Foreign Application Priority Data
May 22, 2013 (CN) 201310192681.1

(51) Int. Cl. H04L 29/08

(52) U.S. Cl. CPC H04L 67/02
USPC 709/218

(57) ABSTRACT

A page responding message including an image sent by a website server is received. Image address information of the image is calculated. Based on a result of the calculation, rendering domain name address information matching the result is searched from a pre-stored domain name address information resource pool. The searched rendering domain name address information and the image address information of the image included in the page responding message are combined as loading address information of the image. The image is loaded into a page corresponding to the domain name address information of the image included in the page responding message based on the loading address information of the image. The present techniques change the loading address information of the image with the same domain by loading address information with different domain names, thereby avoiding the limit to the number of parallel connections under the same domain name.

### CROSS REFERENCE TO RELATED PATENT APPLICATIONS

This application claims foreign priority to Chinese Patent Application No. 201310192681.1 filed on 22 May 2013, entitled “Method and Device for Loading Image Information,” which is hereby incorporated by reference in its entirety.

### TECHNICAL FIELD

The present disclosure is related to the field of Internet information processing, and, more particularly, to a method and a device for loading image information when webpage information is visited through a browsing software.

### BACKGROUND

With the development of Internet technology, more and more information is obtained by people through the Internet by using browsing software. In addition to text information, the obtained information also includes image information and audio and video information.

Generally, a page corresponding to a webpage address includes a lot of image information. When the page is visited by different browsing software, the loading speed of loading the image information into the page differs. Some browsing software has a high loading speed to load image information while some browsing software has a low loading speed. The reason that the image information loaded into the page has different speeds when the page including the lot of image information is visited, is that different browsing software has different limits to a number of parallel connections with the image information under the same domain name.

That is, when some domain information included in address information of the lot of image information is the same, and different browsing software is used to visit the page that includes the lot of image information, the number of parallel connections for image information under the same domain name configured by the different browsing software is different. Thus, the loading speeds of loading the image information into the page are different. FIG. 1 illustrates a diagram of example address information of a page that includes image information.

As shown in FIG. 1, in http://img.china.alibaba.com/images/2012/pic1.png, http://img.china.alibaba.com is a domain name information portion and images/2012/pic1.png is an image address information portion.

For example, the number of parallel connections for image information under the same domain name set by a browsing software A is 8. When using the browsing software A to visit any page, the number of parallel connections for image information is 8. The number of parallel connections for image information under the same domain name configured by a browsing software B is 16. When using the browsing software B to visit any page, the number of parallel connections for image information is 16. Thus, for the same page, a speed that the browsing software B loads the image information is higher than a speed that browsing software A loads the image information.

The conventional techniques cannot avoid or reduce the limit of the number of parallel connections that using the browsing software to visit the image information under the same software. Thus, when the user uses the conventional techniques to visit the page and the lot of image information is loaded, the loading of the image information often excludes each other. That is, the loading of the lot of image information fails, thereby reducing a page display speed and causing an extension of time that the user visits the page.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present techniques improve diversity of results in the direction technology.

The present disclosure provides a method and a device for loading image information. The present techniques resolve a low page display speed caused by a failure of loading of a lot of image information.

The present disclosure provides a method for loading image information. A page responding message including an image sent by a website server is received. Image address information of the image included in the page responding message is calculated. Based on a result of the calculation, rendering domain name address information matching the result is searched from a pre-stored domain name address information resource pool.

The searched rendering domain name address information and the image address information of the image included in the page responding message are combined as loading address information of the image. The image is loaded into a page corresponding to the domain name address information of the image included in the page responding message based on the loading address information of the image.

The present disclosure also provides a device for loading image information. The device may include a receiving module, a domain name address calculating module, and a loading module. The receiving module receives a page responding message including an image sent by a website server. The domain name address calculating module calculates image address information of the image included in the page responding message, and, based on a result of the calculation, searches rendering domain name address information matching the result from a pre-stored domain name address information resource pool.

The loading module combines the searched rendering domain name address information and the image address information of the image included in the page responding message as loading address information of the image, and loads the image into a page corresponding to the domain name address information of the image included in the page responding message based on the loading address information of the image.

The present techniques receive a page responding message including an image sent by a website server, calculate image address information of the image included in the page responding message, and, based on a result of the calculation, search rendering domain name address information matching the result from a pre-stored domain name address information resource pool. The present techniques combine the searched rendering domain name address information and the image address information of the image included in the page responding message as loading address information of the image, and load the image into a page corresponding to the domain name address information of the image included in the page responding message based on the loading address information of the image. Compared with the conventional techniques, the present techniques change the loading address information of the image by loading address information of different domain names for loading, thereby avoiding the limit of the number of parallel connections under the same domain name for the browsing software, increasing a page display speed, and improving user experience.

### BRIEF DESCRIPTION OF THE DRAWINGS

FIG. 1 is a diagram illustrating example address information of a page that includes image information.

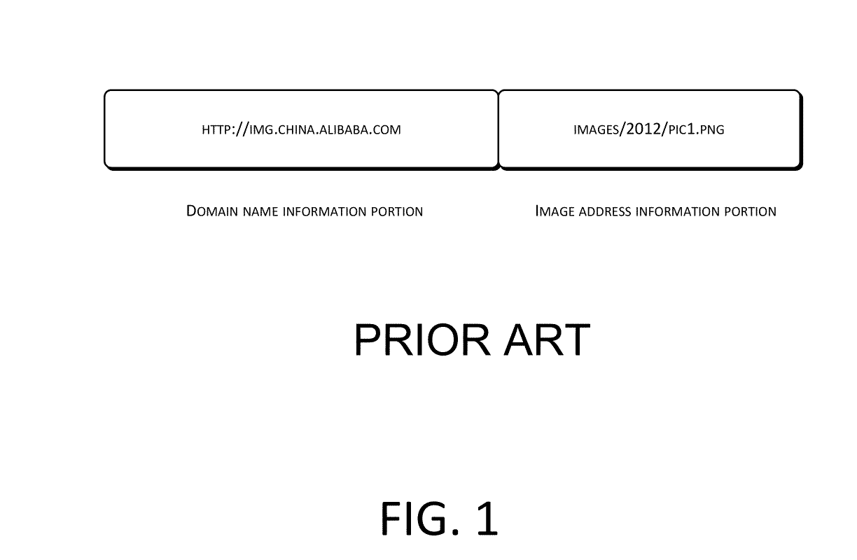

FIG. 2 is a flowchart illustrating an example method for loading an image in accordance with a first example embodiment of the present disclosure.

FIG. 3 is a flowchart illustrating another example method for loading an image in accordance with a second example embodiment of the present disclosure.

FIG. 4 is a diagram illustrating loading an image information under a same domain name in accordance with the conventional techniques and the present techniques.

FIG. 5 is a schematic diagram that illustrates an example device for loading an image in accordance with a third example embodiment of the present disclosure.

### DETAILED DESCRIPTION

The present disclosure provides a method and a device for loading image information. The present techniques receive a page responding message including an image sent by a website server, calculate image address information of the image included in the page responding message, and, based on a result of the calculation, search rendering domain name address information matching the result from a pre-stored domain name address information resource pool. The present techniques combine the searched rendering domain name address information and the image address information of the image included in the page responding message as loading address information of the image, and load the image into a page corresponding to the domain name address information of the image included in the page responding message based on the loading address information of the image. Compared with the conventional techniques, the present techniques change the loading address information of the image by loading address information of different domain names for loading, thereby avoiding the limit of the number of parallel connections under the same domain name for the browsing software, increasing a page display speed, and improving user experience.

The following describes example embodiments in detail by reference to the FIGS.

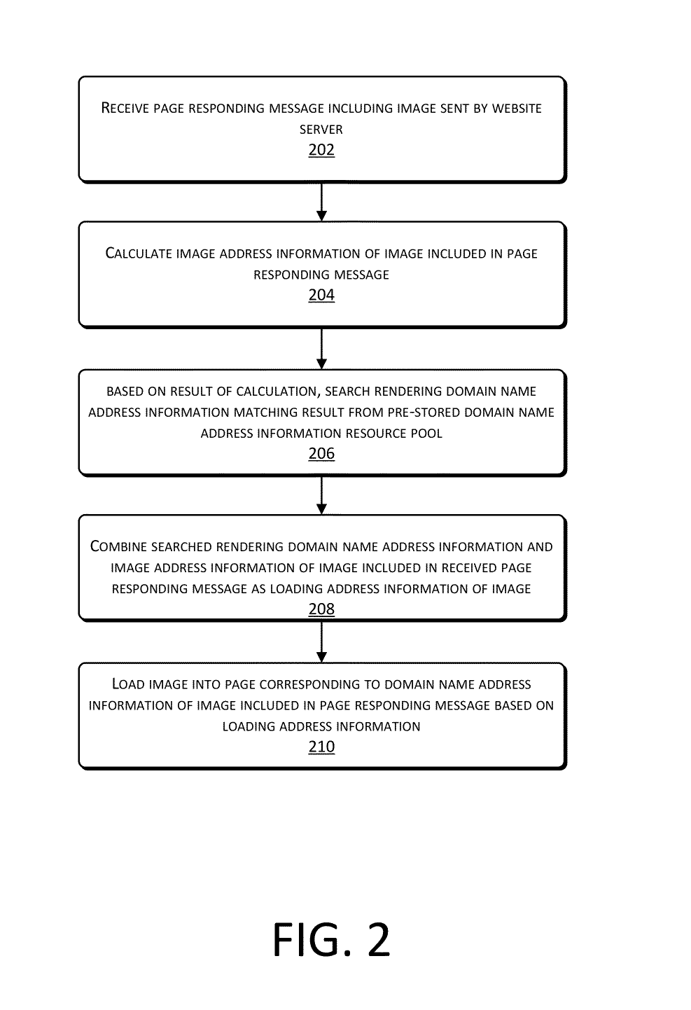

FIG. 2 is a flowchart illustrating an example method for loading an image in accordance with a first example embodiment of the present disclosure.

At 202, a page responding message including an image sent by a website server is received.

For example, at 202, when a user sends a page visit requesting message including page address information to the website server through a browsing software, the website server, based on the page address information included in the page visit requesting message, searches loading address information of data information included in a page from a back-end database, and includes the searched loading address information in the page responding message to send to a multi-domain name rendering engine device.

The data information may include at least one of the following or any combination thereof: text information, image information, and audio or video information.

The multi-domain name rendering engine device includes a domain name address information resource pool. The domain name address resource pool includes rendering domain name address information of different data information, such as rendering domain name address information of image information, rendering domain name address information of audio information. The domain name address resource pool also include rendering domain name address information corresponding to different domain names, in which each domain name corresponds to a rendering domain name address set and each rendering domain name address set includes at least a number of N rendering domain name address information.

N is a positive integer and may be determined by actual needs or data volume included in the page.

For example, IP address is 192.168.0.0 and its corresponding domain name address information is http://www.XXXX.com. A page corresponding to the domain name address information includes image information of 100 images. In the domain name address information resource pool included in the multi-domain name rendering engine device, the domain name address information corresponds to at least 100 rendering domain name address information. That is, each image's address information corresponds to one rendering domain name address information.

At 204, image address information of the image included in the page responding message is calculated.

For example, when the multi-domain name rendering engine device receives the page responding message including the image from the website server, the multi-domain name rendering engine device analyzes the loading address information of the image included in the page responding message, and determines image address information of the image.

For instance, the loading address information of the image included in the page responding message sent by the website server and received by the multi-domain name rendering engine device is http://img.china.alibaba.com/images/2012/pic1.png. The loading address information of the image included in the received page responding message is analyzed and the domain name address information is obtained as http://img.china.alibaba.com and the image address information is obtained as images/2012/pic1.png.

Secondly, the image address information of the image included in the page responding message is calculated. For example, a hash algorithm may be used to determine a hash value of the image address information of the image included in the page responding message and the determined hash value is used to conduct a modular operation.

For instance, the analyzed domain name address information is http://img.china.alibaba.com and its corresponding rendering domain name address set includes 100 rendering domain name address information. One determined image address information is images/2012/pic1.png. A hash value of “images/2012/pic1.png” is calculated and the calculated hash value and 100 are conducted a modular operation and a mold value is obtained as 99.

At 206, based on a result of the calculation, rendering domain name address information matching the result is searched from a pre-stored domain name address information resource pool.

For example, at 206, based on the result of the calculation, before rendering domain name address information matching the result is searched from the pre-stored domain name address information resource pool, the example method may further include the following. According to the domain name address information included in the received page responding message, the rendering domain name address set corresponding to the domain name address information is searched from the pre-stored domain name address information resource pool.

For instance, the loading address information of the image included in the page responding message sent by the website server and received by the multi-domain name rendering engine device is http://img.china.alibaba.com/images/2012/pic1.png. The analyzed domain name address information is http://img.china.alibaba.com. A corresponding rendering domain name address set corresponding to the address information “http://img.china.alibaba.com” is searched from the pre-stored domain name address information resource pool.

For instance, the rendering domain name address set corresponding to the address information “http://img.china.alibaba.com” searched from the pre-stored domain name address information resource pool is {http://i01.aliimg.com, http://i02.aliimg.com, . . . , http://i0m.aliimg.com, . . . http://i100.aliimg.com}. In other words, the rendering domain name address set corresponding to the address information “http://img.china.alibaba.com” includes 100 rendering domain name addresses.

For example, based on the result of the calculation, the domain name address information matching the result is searched from the pre-stored domain name address information resource pool may include the following.

According to a corresponding relationship between a pre-stored result of calculation and the rendering domain name address information, the rendering domain name address information corresponding to the result of calculation is searched from the determined rendering domain name address set.

For instance, a corresponding relationship between a pre-stored mold value and rendering domain name address information is stored. Based on the corresponding relationship between the pre-stored mold value and the rendering domain name address information, serial number information of rendering domain name address information corresponding to the mold value 99 is determined as 99. In other words, the searched rendering domain name address information corresponding to the result of calculation is http://i99.aliimg.com.

At 208, the searched rendering domain name address information and the image address information of the image included in the received page responding message are combined as loading address information of the image.

For example, at 208, the operations that the searched rendering domain name address information and the image address information of the image included in the received page responding message are combined as the loading address information of the image may include the following.

Firstly, original domain name address information of the image is determined according to the domain name address information included in the received page responding message.

For instance, the loading address information of the image included in the page responding message sent by the website server and received by the multi-domain name rendering engine device is http://img.china.alibaba.com/images/2012/pic1.png. The determined original domain name address information of pic1 is http://img.china.alibaba.com.

Secondly, the searched rendering domain name address information is used to replace the determined original domain name address information and is combined with the image address information of the image included in the received page responding message.

For instance, the searched rendering domain name address information (e.g., http://i99.aliimg.com) is used to replace the determined original domain name information of pic1 (e.g., http://img.china.alibaba.com) and is combined with the image address information of the image included in the received page responding message (e.g., images/2012/pic1.png), and the combined address information is, for example, http://i99.aliimg.com/images/2012/pic1.png.

Finally, the combined address information is used as the loading address information of the image. In other words, http://i99.aliimg.com/images/2012/pic1.png is the loading address information of pic1.

At 210, the image is loaded into a page corresponding to the domain name address information of the image included in the page responding message based on the loading address information.

The image is determined according to the image address information of the image included in the received page responding message.

For example, at 210, the multi-domain name address rendering engine device sends the changed loading address information of the image to the browsing software, instructs the browsing software to obtain the image from an image information database according to image address information included in the loading address information, and uses the loading address information to load and render the image at the page corresponding to the domain name address information of the image included in the page responding message for display.

As the domain name address information in the loading address information of the image is changed from single domain name address information to different domain name address information, the present techniques avoid the limit to the number of image information loading connections under the same domain name address information when the browsing software loads the image information, increase a number of parallel connections for loading the image information, and increase the page display speed.

The present techniques receive a page responding message including an image sent by a website server, calculate image address information of the image included in the page responding message, and, based on a result of the calculation, search rendering domain name address information matching the result from a pre-stored domain name address information resource pool. The present techniques combine the searched rendering domain name address information and the image address information of the image included in the page responding message are combined as loading address information of the image, and load the image into a page corresponding to the domain name address information of the image included in the page responding message based on the loading address information of the image. Compared with the conventional techniques, the present techniques change the loading address information of the image into loading address information of different domain names to load, thereby avoiding the limitation of the number of parallel connections for a browsing software, increasing a page display speed, and improving user experience.

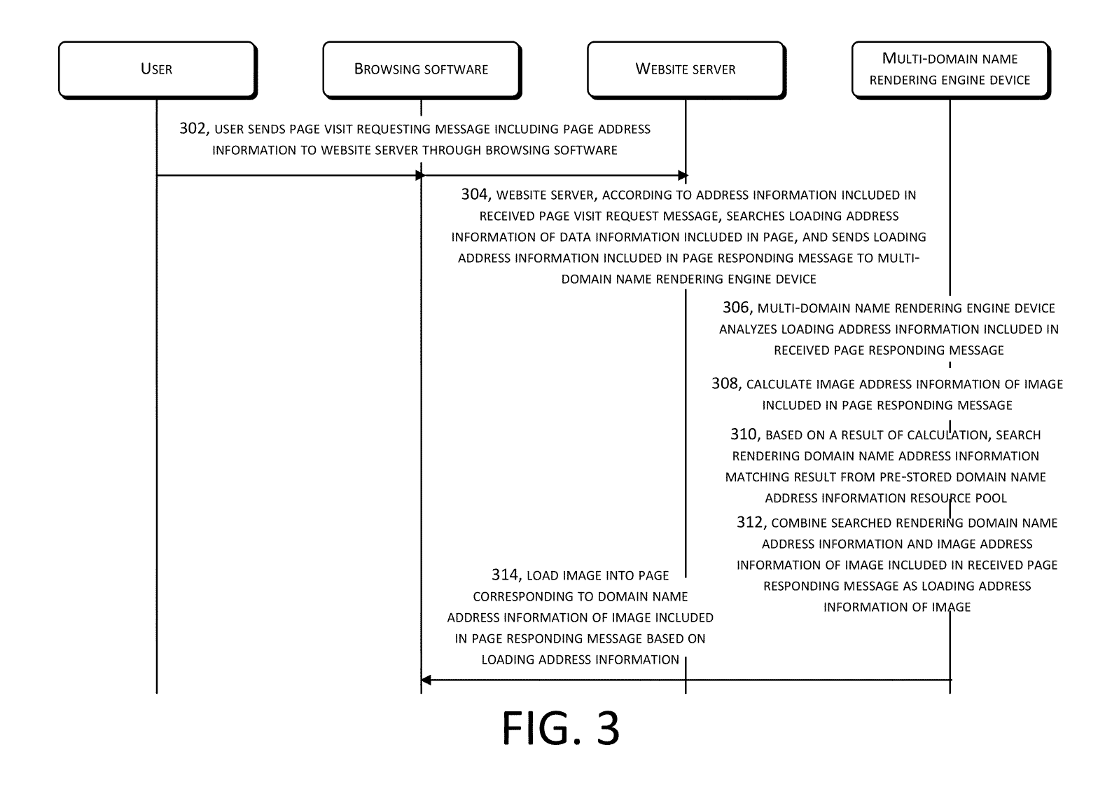

FIG. 3 is a flowchart illustrating another example method for loading image in accordance with a second example embodiment of the present disclosure. The second example embodiment describes the operations at the first example embodiment in detail.

At 302, the user sends the page visit requesting message including the page address information to the website server through the browsing software.

For example, the browsing software may be IE 6.0, IE 7.0, IE 8.0, or any plug-in that has functionality of the browsing software.

For instance, the page address information included in the page visit requesting message sent from the user to the website server through the browsing software is http://img.china.alibaba.com.

At 304, the website server, according to the address information included in the received page visit request message, searches the loading address information of the data information included in the page, and sends the searched loading address information included in the page responding message to the multi-domain name rendering engine device.

At 304, by using the example of loading image information, the website server, according to the address information http://img.china.alibaba.com included in the received page visit request message, searches the loading address information of the image included in the page.

For example, the loading address information of the image included in the page is as follows:

http://img.china.alibaba.com/images/2012/pic1.png,

http://img.china.alibaba.com/images/2012/pic2.png,

http://img.china.alibaba.com/images/2012/pic3.png,

http://img.china.alibaba.com/images/2012/pic4.png,

At 306, the multi-domain name rendering engine device analyzes the loading address information included in the received page responding message.

For example, at 306, the multi-domain name rendering engine device analyzes the loading address information included in the received page responding message, and determines the domain name address information and the image address information of each received image.

For instance, the loading address information of the received image http://img.china.alibaba.com/images/2012/pic1.png is analyzed, and the domain name address information of the image with the identification pic1 is obtained as http://img.china.alibaba.com and its image address information is obtained as images/2012/pic1.png. The loading address information of the received image http://img.china.alibaba.com/images/2012/pic2.png is analyzed, and the domain name address information of the image with the identification pic2 is obtained as http://img.china.alibaba.com and its image address information is obtained as images/2012/pic2.png. The loading address information of the received image http://img.china.alibaba.com/images/2012/pic3.png is analyzed, and the domain name address information of the image with the identification pic3 is obtained as http://img.china.alibaba.com and its image address information is obtained as images/2012/pic3.png. The loading address information of the received image http://img.china.alibaba.com/images/2012/pic4.png is analyzed, and the domain name address information of the image with the identification pic4 is obtained as http://img.china.alibaba.com and its image address information is obtained as images/2012/pic4.png.

Thus, the images with the identifications pic1, pic2, pic3, and pic4 are image information of the same domain name. When the browsing software loads the images, it is subject to the limit of the number of loading connections for images under the same domain name.

At 308, image address information of the image included in the page responding message is calculated.

For example, at 308, the hash algorithm is used to determine the hash value of the image address information of the image included in the page responding message and the determined hash value is used for modular operation.

In addition to the hash algorithm, some other algorithms may be used. The present techniques do not impose any limitation.

When the determined hash value is used for modular operation, the number that is applied the modular operation may be a number of images included in the page or a number of rendering domain name address information corresponding to the same domain name is the domain name address information resource pool. The present techniques do not impose any restriction herein.

For instance, the number of images included in the page is 4. One determined image address information is images/2012/pic1.png. A hash value of “images/2012/pic1.png” is calculated. Its calculated hash value and 4 are conducted the modular operation and the obtained mold value is 4. The determined image address information is images/2012/pic2.png. A hash value of “images/2012/pic2.png” is calculated. Its calculated hash value and 4 are conducted the modular operation and the obtained mold value is 2. One determined image address information is images/2012/pic3.png. A hash value of “images/2012/pic3.png” is calculated. Its calculated hash value and 4 are conducted the modular operation and the obtained mold value is 3. One determined image address information is images/2012/pic4.png. A hash value of “images/2012/pic4.png” is calculated. Its calculated hash value and 4 are conducted the modular operation and the obtained mold value is 1.

At 310, based on a result of the calculation, rendering domain name address information matching the result is searched from the pre-stored domain name address information resource pool.

For example, at 310, firstly, according to the domain name address information of the image included in the page responding message, a rendering domain name address set corresponding to the domain name address information is searched from the pre-stored domain name address information resource pool.

For instance, the loading address information of the image included in the page responding message sent by the website server and received by the multi-domain name rendering engine device is as follows:

http://img.china.alibaba.com/images/2012/pic1.png,

http://img.china.alibaba.com/images/2012/pic2.png,

http://img.china.alibaba.com/images/2012/pic3.png,

http://img.china.alibaba.com/images/2012/pic4.png,

The analyzed domain name address information is http://img.china.alibaba.com. A rendering domain name address set corresponding to the address information “http://img.china.alibaba.com” searched from the pre-stored domain name address information resource pool is {http://i01.aliimg.com, http://i02.aliimg.com, http://i03.aliimg.com, http://i04.aliimg.com}. In other words, the rendering domain name address set corresponding to the address information “http://img.china.alibaba.com” includes 4 rendering domain name addresses.

Then, according to a corresponding relationship between the pre-stored result of calculation and the rendering domain name address information, the rendering domain name address information corresponding to the result of calculation is searched from the determined rendering domain name address set.

For instance, the corresponding relationship between the pre-stored mold value and the rendering domain name address information is stored. Based on the corresponding relationship between the pre-stored mold value and the rendering domain name address information, serial number information of rendering domain name address information corresponding to the mold value 4 is determined as 4. In other words, the searched rendering domain name address information corresponding to the result of calculation is http://i04.aliimg.com. The serial number information of rendering domain name address information corresponding to the mold value 3 is determined as 3. In other words, the searched rendering domain name address information corresponding to the result of calculation is http://i03.aliimg.com. The serial number information of rendering domain name address information corresponding to the mold value 2 is determined as 2. In other words, the searched rendering domain name address information corresponding to the result of calculation is http://i02.aliimg.com. The serial number information of rendering domain name address information corresponding to the mold value 1 is determined as 1. In other words, the searched rendering domain name address information corresponding to the result of calculation is http://i01.aliimg.com.

For instance, assuming that the limit of the number of parallel connections that the browsing software loads the image information under the same domain name is 2, i.e., the number of one-time loading image information under the same domain name is 2, under the conventional techniques, the image information with the identifications pic1, pic2, pic3, and pic4 under the same domain name needs loading twice, thereby reducing the page display speed.

Thus, before the searched rendering domain name address information and the image address information of the image included in the received page responding message are combined as the loading address information of the image, the example method may further include the following.

Firstly, a number of image information under the same domain name is determined for loading the image information.

Secondly, based on the limit of a number of parallel connections for the image information under the same domain name imposed by the browsing software, the image information under the same domain name is grouped.

For example, a grouping rule may include, with respect to loading the image information, determining a quotient of the number of image information under the same domain name to the limit of the number of parallel connections for the image information under the same domain name.

For instance, the number of the image information under the same domain name is 4 (with identifications pic1, pic2, pic3, and pic4). The limit of the number of parallel connections that the browsing software loads the image information under the same domain name is 2. According to the grouping rule, {image information with the identification pic1, image information with the identification pic2} is one group, and {image information with the identification pic3, image information with the identification pic4} is another group.

Thirdly, the image address information of each image information in each group is conducted hash calculation and a mold value corresponding to each hash value is determined.

For example, the number that is applied the modular operation may be the limit of the number of parallel connections that the browsing software loads the image information under the same domain name.

For instance, the determined image address information is images/2012/pic1.png. A hash value of “images/2012/pic1.png” is calculated. Its calculated hash value and 2 are conducted the modular operation and the obtained mold value is 2. The determined image address information is images/2012/pic2.png. A hash value of “images/2012/pic2.png” is calculated. Its calculated hash value and 2 are conducted the modular operation and the obtained mold value is 1. The determined image address information is images/2012/pic3.png. A hash value of “images/2012/pic3.png” is calculated. Its calculated hash value and 2 are conducted the modular operation and the obtained mold value is 1. The determined image address information is images/2012/pic4.png. A hash value of “images/2012/pic4.png” is calculated. Its calculated hash value and 2 are conducted the modular operation and the obtained mold value is 2.

Fourthly, the rendering address information of image information with the same mold value is determined as the same.

In other words, the rendering address information of the image information with the identification pic1 and the image information with the identification pic4 are the same. The rendering address information of the image information with the identification pic2 and the image information with the identification pic3 are the same.

When the mold value is not an integer, a closest integer to the mold value may be used.

At 312, the searched rendering domain name address information and the image address information of the image included in the received page responding message are combined as loading address information of the image.

At 314, the image is loaded into a page corresponding to the domain name address information of the image included in the page responding message based on the loading address information.

Based on the present techniques in the second example embodiment, when the rendering domain name address information of each image information is determined, image information with the same domain name is grouped. The rendering domain name address information of each image information in each group is determined and the rendering domain name address information of image information with same result of calculation in different groups are set as the same, thereby reducing the calculation volume, avoiding the limit of parallel connections for image information under the same domain name imposed by the browsing software, increasing the page display speed, and improving the user experience.

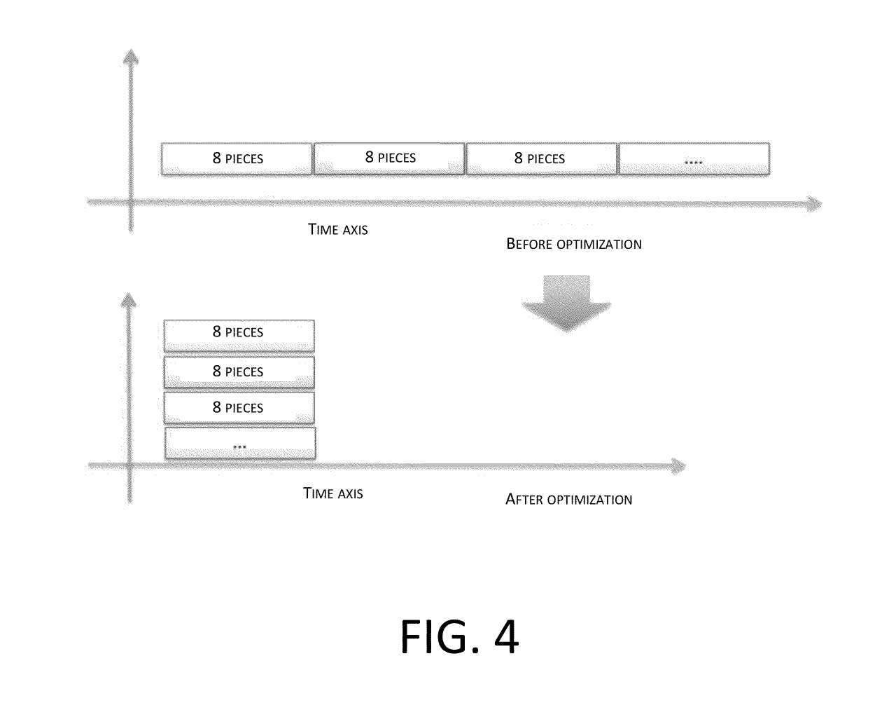

FIG. 4 is a diagram illustrating loading image information under a same domain name in accordance with the conventional techniques and the present techniques.

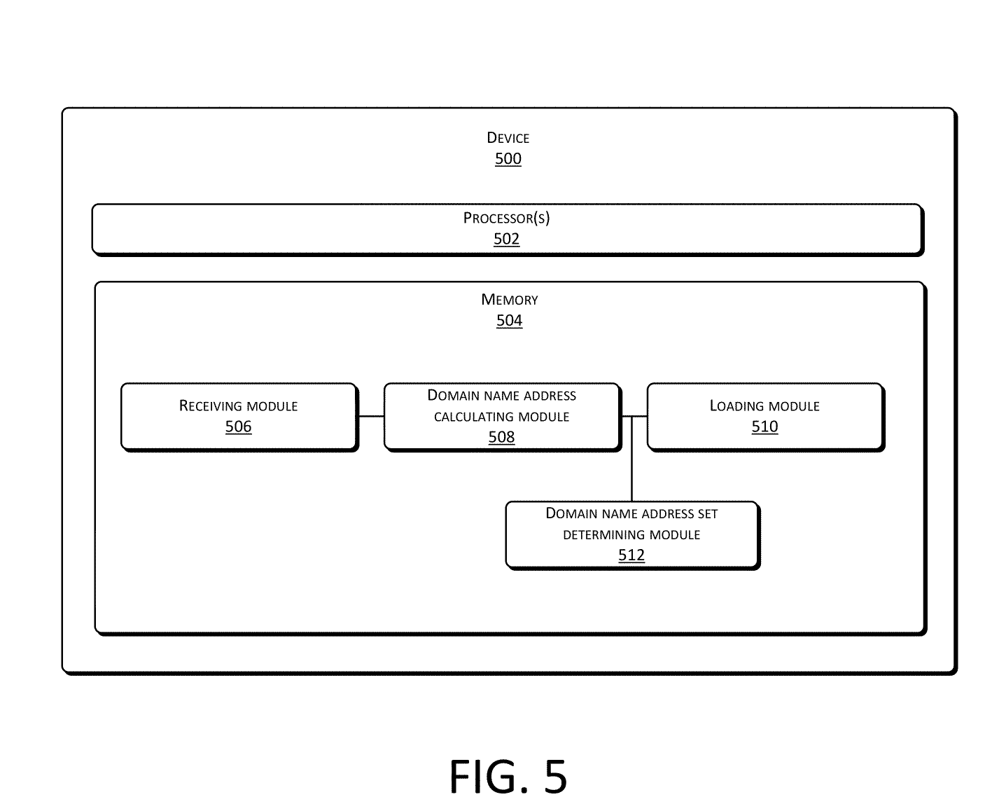

FIG. 5 is a schematic diagram that illustrates an example device 500 for loading image in accordance with a third example embodiment of the present disclosure. The third example embodiment illustrates a device that implements same concepts under the first and the second example embodiments. The device 500 may include one or more processor(s) 502 and memory 504. In the example of FIG. 5, the memory 504 may store therein a receiving module 506, a domain name address calculating module 508, and a loading module 510.

The receiving module 506 receives a page responding message including an image sent by a website server.

The domain name address calculating module 508 calculates image address information of the image included in the page responding message, and, based on a result of the calculation, searches rendering domain name address information matching the result from a pre-stored domain name address information resource pool.

The loading module 510 combines the searched rendering domain name address information and the image address information of the image included in the page responding message as loading address information of the image, and loads the image into a page corresponding to the domain name address information of the image included in the page responding message based on the loading address information of the image. The image is determined according to the image address information of the image included in the received page responding message.

For example, the domain name address calculating module 508 may use a hash algorithm to determine a hash value of the image address information of the image included in the page responding message and use the determined hash value to conduct a modular operation.

For example, the device 500 may further include a domain name address set determining module 512. The domain name address set determining module 512, after the page responding message including the image, sent by the website server, is received, and before the rendering domain name address information matching the result is searched, searches a rendering domain name address set corresponding to the domain name address information from a pre-stored domain name address information resource pool according to the domain name address information included in the page responding message.

For example, the domain name address set determining module 512, according to a pre-stored corresponding relationship between the result of the calculation and the rendering domain name address information, searches the rendering domain name address information corresponding to the result of the calculation from the pre-stored domain name address information resource pool.

For example, the loading module 510 determines original domain name address information according to the domain name address information included in the received page responding message, replaces the determined original domain name address information by the searched rendering domain name address information, combines the determined original domain name address information with the image address information included in the received page responding message, and uses the combined address information as the loading address information of the image.

For example, the device as described in the example embodiment may be the multi-domain name rendering engine device.

In a standard configuration, a computing device as described in the present disclosure may include one or more central processing units (CPU), input/output interfaces, and memory. The memory may include forms such as non-permanent memory, random access memory (RAM), and/or non-volatile memory such as read only memory (ROM) and flash random access memory (flash RAM) in the computer-readable media. The memory is an example of computer-readable media. The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

One of ordinary skill in the art would understand that the example embodiments may be presented in the form of a method, an apparatus (device), or a computer software product. Thus, the present techniques may be implemented by hardware, computer software, or a combination thereof. In addition, the present techniques may be implemented as the computer software product that is in the form of one or more computer storage media (including, but is not limited to, disk, CD-ROM, or optical storage device) that include computer-executable or computer-readable instructions.

The present techniques are described by reference to the flowcharts or diagrams of the methods, apparatuses (devices), or computer software products. It should be understood that the computer-executable instructions may implement each process or box in the flowcharts and/or diagrams, and a combination of processes and/or boxes in the flowcharts and/or diagrams. The computer-executable instructions may be provided to one or more processors at a general-purpose computer, a special-purpose computer, an embedded computer, or any other programmable data processing device to generate a machine, through which the computer-executable instructions executed by the processors of the computer or any other programmable data processing process implements the designated functionalities of one or more processes at the flowcharts and/or one or more boxes at the diagrams.

The computer-executable instructions may be stored at one or more computer-readable media that leads the computer or any other programmable data processing device to work in specific methods so that the computer-executable instruction stored at the computer-readable media produce a product that includes an instruction apparatus. The instruction apparatus implements the designated functionalities of one or more processes at the flowcharts and/or one or more boxes at the diagrams.

The computer-executable instructions may also be loaded at the computer or any other programmable data processing device so that the computer or any other programmable data processing devices performs a series of operations to produce processes implemented by the computer. Thus, the computer-executable instructions executable by the computer or any other programmable device provide operations to implement the designated functionalities of one or more processes at the flowcharts and/or one or more boxes of the diagrams.

Although the present disclosure describes the example embodiments, one of ordinary skill in the art could make changes and modifications to the example embodiments once he/she know those basic creative concepts as described herein. Thus, the appended claims shall be construed to cover the example embodiments and all changes and modifications that fall into the scope of the present disclosure. Furthermore, one of ordinary skill in the art may make any revisions or variations to the present techniques without departing the spirit and scope of the present techniques. Thus, in case such revisions or variations fall under the scope of the claims of the present techniques and its equivalent techniques, the present disclosure also intends to cover such revisions or variations.

What is claimed is:

1. A method comprising:
receiving a page responding message including an image;
calculating image address information of the image included in the page responding message;
based on a result of the calculating, searching rendering domain name address information matching the result from a pre-stored domain name address information resource pool; and
combining the searched rendering domain name address information and the image address information as loading address information of the image.

2. The method of claim 1, further comprising loading the image into a page corresponding to domain name address information of the image based on the loading address information.

3. The method of claim 1, wherein the page responding message is sent by a website server.

4. The method of claim 1, wherein the calculating the image address information of the image included in the page responding message comprises:
using a hash algorithm to determine a hash value of the image address information of the image; and
using the determined hash value for a modular operation.

5. The method of claim 1, further comprising:
after receiving the page responding message including the image and before calculating the image address information of the image, according to domain name address information of the image, searching a rendering domain name address set corresponding to the domain name address information from a pre-stored domain name address information resource pool.

6. The method of claim 5, wherein the searching the rendering domain name address information matching the result from the pre-stored domain name address information resource pool comprises, according to a corresponding relationship between a pre-stored result of calculation and the rendering domain name address information, searching the rendering domain name address information corresponding to the result of calculation from the determined rendering domain name address set.

7. The method of claim 1, wherein the combining the searched rendering domain name address information and the image address information as the loading address information of the image comprises
determining original domain name address information of the image according to domain name address information of the image included in the received page responding message;
replacing the determined original domain name address information by the searched rendering domain name address information; and
combining the rendering domain name address information with the image address information included in the received page responding message as the loading address information of the image.

8. A device comprising:
a receiving module that receives a page responding message including an image;
a domain name address calculating module that calculates image address information of the image included in the page responding message and, based on a result of the calculating, searches rendering domain name address information matching the result from a pre-stored domain name address information resource pool; and
a loading module that combines the searched rendering domain name address information and the image address information as loading address information of the image.

9. The device of claim 8, wherein the loading module further loads the image into a page corresponding to domain name address information of the image based on the loading address information.

10. The device of claim 8, wherein the page responding message is sent by a website server.

11. The device of claim 8, wherein the domain name address calculating module further uses a hash algorithm to determine a hash value of the image address information of the image and uses the determined hash value for a modular operation.

12. The device of claim 8, further comprising a domain name address set determining module that, after the page responding message including the image, sent by the website server, is received, and before the rendering domain name address information matching the result is searches, searches a rendering domain name address set corresponding to the domain name address information from a pre-stored domain name address information resource pool according to the domain name address information included in the page responding message.

13. The device of claim 12, wherein the domain name address calculating module, according to a corresponding relationship between a pre-stored result of calculation and the rendering domain name address information, searches the rendering domain name address information corresponding to the result of calculation from the determined rendering domain name address set.

14. The device of claim 8, wherein the loading module further:
determines original domain name address information of the image according to domain name address information of the image included in the received page responding message;
replaces the determined original domain name address information by the searched rendering domain name address information; and
combines the rendering domain name address information with the image address information included in the received page responding message as the loading address information of the image.

15. One or more computer storage media stored thereon computer-executable instructions executable by one or more processors to perform operations comprising:
receiving a page responding message including an image;
calculating image address information of the image included in the page responding message;
based on a result of the calculating, searching rendering domain name address information matching the result from a pre-stored domain name address information resource pool; and
combining the searched rendering domain name address information and the image address information as loading address information of the image.

16. The one or more computer storage media of claim 15, wherein the operations further comprise loading the image into a page corresponding to domain name address information of the image based on the loading address information.

17. The one or more computer storage media of claim 15, wherein the calculating the image address information of the image included in the page responding message comprises:
using a hash algorithm to determine a hash value of the image address information of the image; and
using the determined hash value for a modular operation.

18. The one or more computer storage media of claim 15, wherein the operations further comprise:
after receiving the page responding message including the image and before calculating the image address information of the image, according to domain name address information of the image, searching a rendering domain name address set corresponding to the domain name address information from a pre-stored domain name address information resource pool.

19. The one or more computer storage media of claim 18, wherein the searching the rendering domain name address information matching the result from the pre-stored domain name address information resource pool comprises, according to a corresponding relationship between a pre-stored result of calculation and the rendering domain name address information, searching the rendering domain name address information corresponding to the result of calculation from the determined rendering domain name address set.

20. The one or more computer storage media of claim 15, wherein the combining the searched rendering domain name address information and the image address information as the loading address information of the image comprises
determining original domain name address information of the image according to domain name address information of the image included in the received page responding message;
replacing the determined original domain name address information by the searched rendering domain name address information; and
combining the rendering domain name address information with the image address information included in the received page responding message as the loading address information of the image.
